(19) United States
(12) Patent Application Publication
(10) Pub. No.: US 2007/0117022 A1
(43) Pub. Date: May 24, 2007

(54) Negative plate for nickel/metal hydride secondary battery and fabrication method thereof

(76) Inventor: Dong Pil Park, Kyunggi-do (KR)

Correspondence Address: RABIN & Berdo, PC, 1101 14TH STREET, NW, SUITE 500, WASHINGTON, DC, 20005, US

(21) Appl. No.: 11/645,005

(22) Filed: Dec. 26, 2006

Related U.S. Application Data
(63) Continuation-in-part of application No. 10/600,169, filed on Jun. 19, 2003, now abandoned.

(51) Int. Cl. H01M 4/70; H01M 4/58

(52) U.S. Cl. 429/241; 29/2; 429/218.2

(57) ABSTRACT

Disclosed is a negative plate for nickel/metal hydride secondary batteries, comprising a negative plate frame; a terminal connected to the negative plate frame; and two or more strips inserted into the negative plate frame, wherein the strip is formed by filling the space between two metal plates having a plurality of perforations formed thereon with electrode material. Further, provided is a method for fabricating such negative plate for nickel/metal hydride secondary batteries, comprising: perforating metal plates to have a plurality of perforations; filling the space between the two metal plates with powders of an electrode material; compressing the two metal plates having the electrode material therebetween, so as to form a strip; connecting two or more, as many as being required for a predetermined capacity, strips formed as above; and inserting connected strips into the negative plate frame so as to connect with an electrode terminal.

### CROSS-REFERENCE TO RELATED APPLICATION

This application is a continuation-in-part of U.S. patent application Ser. No. 10/600,169 filed on Jun. 19, 2003.

### BACKGROUND OF THE INVENTION

The present invention relates to a nickel/metal hydride secondary battery, and more particularly, to a negative plate for rechargeable nickel/metal hydride secondary batteries, and a method of fabricating the same.

In recent years, various environmental regulations have been enforced in many countries as an expression of will to protect the environment. Under such circumstances, in the field of small size batteries, conventional lead acid batteries and nickel/cadmium batteries have already been replaced by nickel/metal hydride, lithium ion batteries or the like. However, in the field of large size batteries for industrial purposes, substitutive environmentally friendly batteries have not been developed yet, which allows still wide use of lead acid batteries and nickle/cadmium batteries. Therefore, there still has been a need for developing environmentally friendly large size nickel/metal hydride batteries with high performance, and various studies thereon are still being carried out.

As for the nickel/metal hydride secondary battery, negative plates therein have a function of emitting and absorbing hydrogen ions at the time of charging and discharging the battery, and also a function of absorbing gases produced at positive electrode plates when the battery is overcharged. Thus, characteristics (e.g. charge and discharge cycle life and high rate discharge) of the nickel/metal hydride secondary battery are mainly dependent upon performances of the negative plates.

Examples of conventional methods of fabricating negative plates for nickel/metal hydride secondary batteries include a fabrication method for a paste-type metal hydride electrode developed by KIST (Korea Institute of Science and Technology), Korea, which is disclosed in U.S. Pat. No. 5,682,592.

According to U.S. Pat. No. 5,682,592, the negative plate is fabricated by mixing a powder-type active material (that is, metal hydride), a binder, a conductor and water at predetermined mixing ratios, and compressing the mixture on nickel screens serving as a collector. At this time, the binder is exemplified by a binding agent (PTFE: polytetrafluoroethylene and 503H) and a thickening agent (HPMC: hydroxypropyl methyl cellulose). As the conductor, nickel, copper, graphite or AB (acetylene black) in the form of powders is used in an amount of 5-10 wt %.

However, in the negative plate for nickel/metal hydride electrode fabricated according to conventional methods, quantities of metal hydride powders decrease proportionally to an increasing quantity of the binder and the conductor, thus reducing the capacity of the secondary battery using such negative plates.

In addition, the electrode is subject to continuous expansion and contraction during repeated discharge and recharge. This makes the metal hydride break into small particles, since the metal hydride powders are applied to an outer wall of the nickel screens. Accordingly, the metal hydride particles fall down from the electrode.

With reference to FIG. 6B, a cycle life of the nickel/metal hydride secondary battery using the negative plates according to conventional techniques is shown. As shown in FIG. 6B, after charge and discharge cycles of the battery are repeated about 500 times, a discharge capacity thereof decreases to about 80%.

Further, conventional negative plates are disadvantageous in that when the electric current flows from the collector (nickel screen) to the metal hydride, the used binder acts as a resistance. Accordingly, as shown in FIG. 7B, the nickel/metal hydride secondary battery using the negative plates according to conventional techniques has a discharge capacity not exceeding about 95% for about 1 hour, on the basis of a 5-hour discharge capacity of 100%.

When, forming an electrode by applying a paste material to a nickel screen, it is hard to make a large size electrode. This is because it is hardly achieved to make the electrode uniform as the size of the electrode increases. Further, when the electrode is not uniformly formed, the performance is deteriorated and minor short circuits are likely to occur.

### SUMMARY OF THE INVENTION

The present invention is to solve the problems of conventional negative plates for nickel/metal hydride secondary batteries.

In order to achieve the above object, one aspect of the present invention is a negative plate for nickel/metal hydride secondary batteries.

A negative plate for nickel/metal hydride secondary batteries according to the present invention comprises: a negative plate frame; a terminal connected to the negative plate frame; and two or more strips inserted into the negative plate frame, wherein the strip is characteristically formed by filling a space between two metal plates having a plurality of perforations formed thereon with electrode material.

In another aspect, the present invention having the above object of the present invention relates to a method for fabricating a negative plate for nickel/metal hydride secondary batteries.

The method for fabricating a such negative plate for nickel/metal hydride secondary batteries according to the present invention, comprises: perforating metal plates to have a plurality of perforations; filling a space between the two metal plates with electrode material; compressing the two metal plates having the electrode material therebetween, so as to form a strip; connecting two or more, as many as being required for a predetermined capacity, strips formed as above; and inserting connected strips into the negative plate frame so as to connect with an electrode terminal.

### BRIEF DESCRIPTION OF THE DRAWINGS

FIG. 1 illustrates a structure of a negative plate for a nickel/metal hydride secondary battery according to a preferred embodiment of the present invention; FIG. 1A is a front view of FIG. 1; FIG. 1B is a sectional view taken along line B-B′ of FIG. 1A; and FIG. 1C is a front view illustrating a modified negative plate of FIG. 1A.

FIG. 2 is a plan view of a perforated plate which constitutes a nickel strip used in a negative plate for a nickel/metal hydride secondary battery according to one preferred embodiment of the present invention.

FIGS. 3A to 3C are schematic views illustrating a process of forming a strip by combining the plates of FIG. 2, and a process of binding the strips together.

FIG. 4 is a process diagram illustrating a method of fabricating the negative plate for nickel/metal hydride secondary batteries of the present invention.

FIG. 5 is a perspective view illustrating a structure of a nickel/metal hydride secondary battery using the negative plates of the present invention.

FIGS. 6A and 6B are graphs each illustrating a cycle life of the nickel/metal hydride secondary battery using the negative plates of the present invention (FIG. 6A) and of a conventional nickel/metal hydride secondary battery (FIG. 6B).

FIGS. 7A and 7B are graphs each illustrating high rate discharge characteristics of the nickel/metal hydride secondary battery using the negative plates of the present invention (FIG. 7A) and of a conventional nickel/metal hydride secondary battery (FIG. 7B).

FIG. 8 is a graph illustrating a recharge-discharge characteristics of the nickel/metal hydride secondary battery using the negative plates of the present invention, as a function of time.

FIG. 9 is a graph illustrating a ΔV behavior of the nickel/metal hydride secondary battery using the negative plates of the present invention.

### DETAILED DESCRIPTION OF THE INVENTION

Hereinafter, a detailed description will be given of exemplary embodiments of a negative plate for nickel/metal hydride secondary batteries and a method of fabricating the same, with reference to the attached drawings.

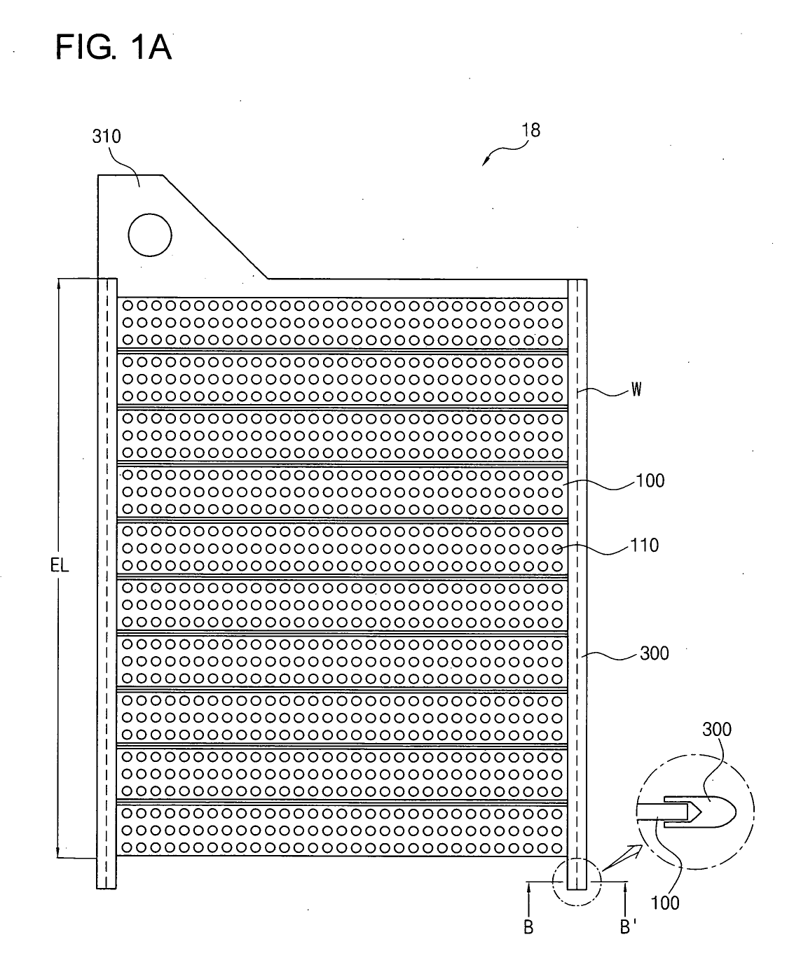

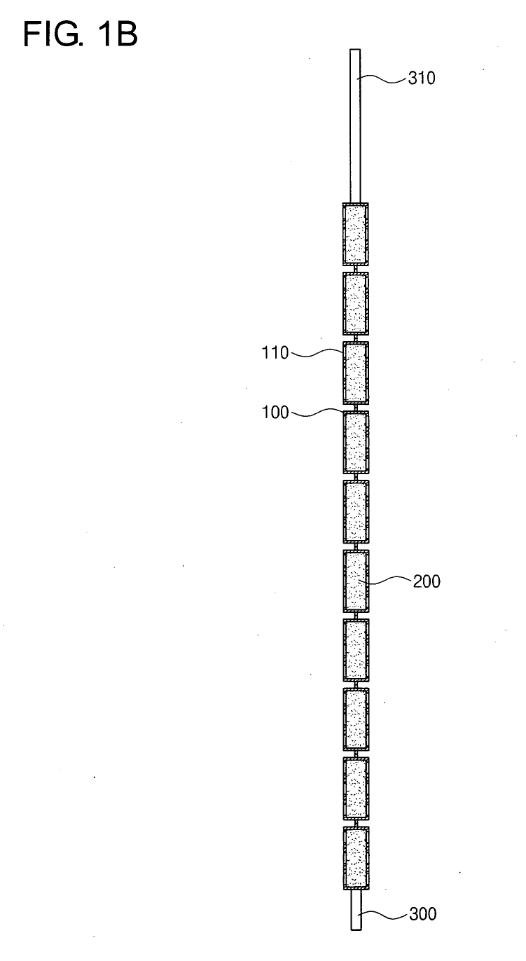

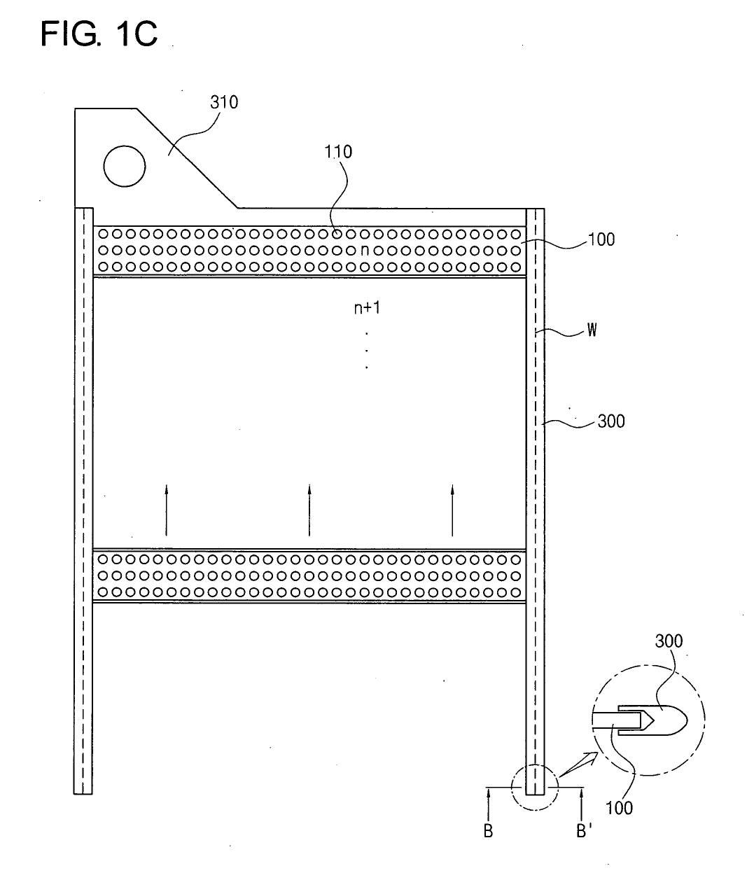

As shown in FIGS. 1A and 1B, a negative plate for nickel/metal hydride secondary batteries includes a plurality of nickel strips 100.

Further, a terminal 310 for charging and discharging the battery is connected to one end of the negative plate frame 300. The nickel strips 100 function as an electric collector. In other words, when electric current is applied to the terminal 310, the nickel strips 100 allow the electric current to flow to the electrode material 200.

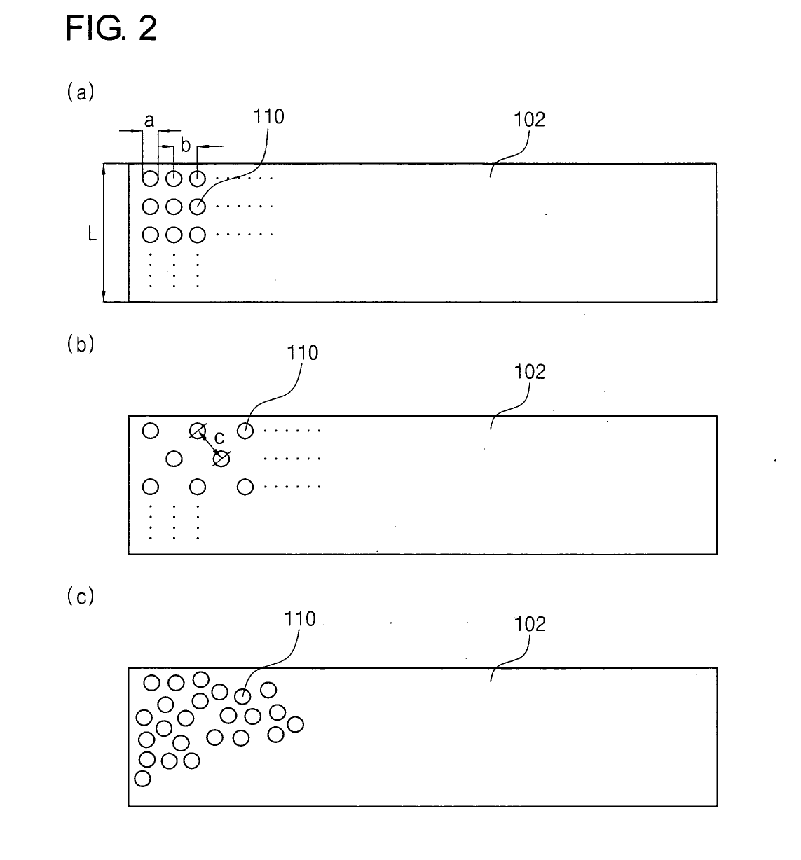

The strip 100 is formed by filling the space between two perforated metal plates 102 with electrode material 200 as shown in FIG. 2. Thus formed strips 100 are connected to each other and inserted into a negative plate frame 300 as shown in the magnified view of the part taken along the line B-B′ of FIG. 1A. Then the perforated nickel plate 102 except the electrode material 200 is provided as a collector.

Perforation 110 is a passage for an electrolyte, which allows the electrolyte of a battery being sufficiently present in the electrode. The metal plate 102 is formed by making a plurality of perforations 110 on a steel plate having the thickness of hundreds of micrometers to several millimeters, and coating the perforated plate with nickel. It is also possible to use a perforated nickel plate to eliminate the coating process. Hereinafter, mainly the case of using a nickel plate is described.

FIGS. 2A to 2C show various types of perforations.

The perforations 110 can be arranged in a row on the plate 102 as shown in FIG. 2A. It is also possible to form such perforations on the cross as shown in FIG. 2B, or randomly as in FIG. 2C. The diameter of the perforations 110 may be tens of micrometers to several millimeters (represented as ‘a’ in FIG. 2A), and the interval between the perforations, represented as ‘b’ and ‘c’ is preferably several micrometers to several millimeters.

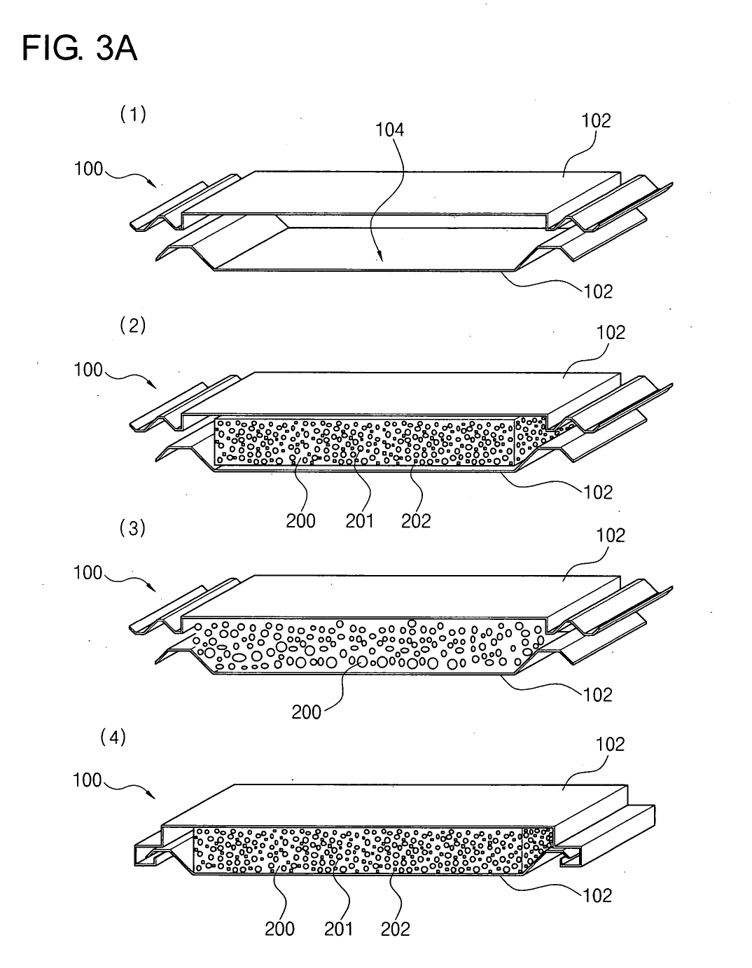

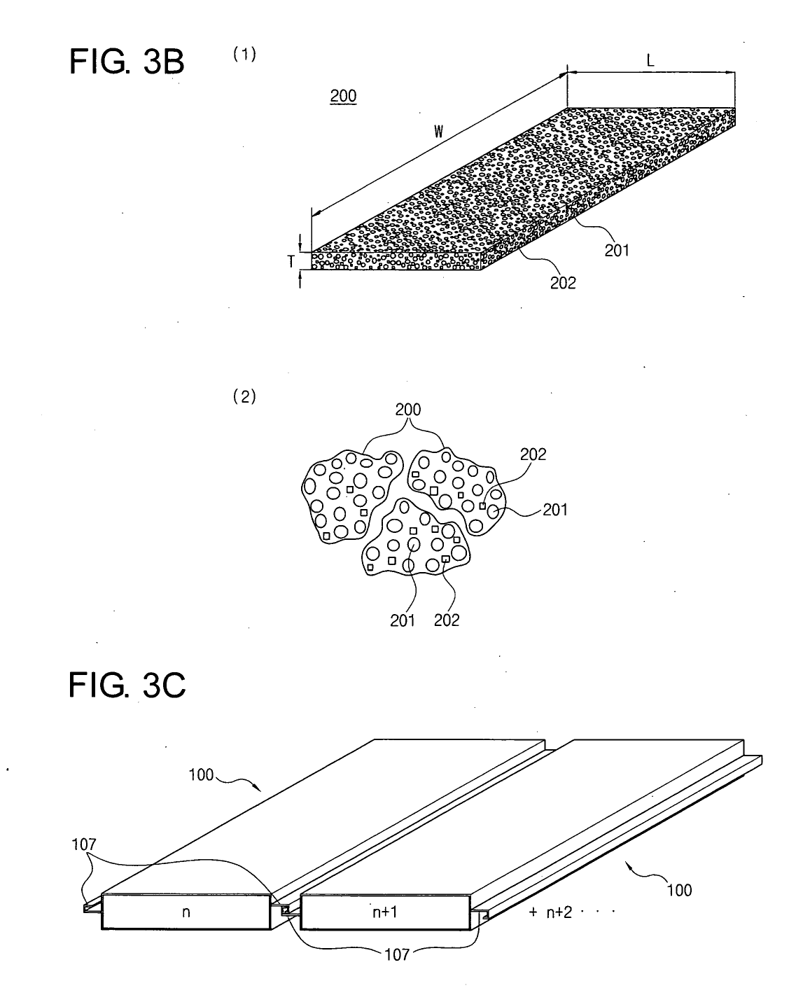

FIGS. 3A to 3C are views schematically illustrating a process of forming a strip 100 by combining two plates. In FIG. 3A, the pair of two perforated nickel plates 102 as prepared above is formed into one strip 100. The nickel plate 102 is shaped to have a recessed area 104 for receiving an electrode material 200, as shown in (1) of FIG. 3A. Between such nickel plates 102 which form an upper and lower part, an electrode material 200 is filled, as shown in (2) or (3) of FIG. 3A. The figure represented in (2) shows the case of filling with a compressed electrode material, and the figure of (3) shows the case of filling with a compressed and then crushed electrode material. After filling with the electrode material 200, each end of the upper and the lower nickel plates 102 is connected together and compressed so as to form one strip 100, as shown in (4) of FIG. 3A.

The electrode material 200 is a mixture of metal hydride 201 and a conductor 202 dispersed to the metal hydride 201, as shown in FIGS. 3A and 3B. This type is different from the conventional paste-type electrode using a binder. The electrode material can be filled into the strip 100, as it is or as a rectangular solid which is formed by compressing, as shown in (1) of FIG. 3B. In the electrode material 200 pelletized into a rectangular solid, the thickness T is larger than the height of the recessed area of the nickel plate 100, and the width W is 500 micrometer smaller than the width of the nickel plate 102. Further, the length (L) is 5 mm or more.

Such metal hydride, serving as a hydrogen storage, is made of a material selected from AB5 based alloys (e.g. MmNi_{3.55}Co_{0.75}Mn_{0.4}Al_{0.3} wherein Mm is Misch metal, that is alloy of rare earth elements, MmNi_{4.3}Mn_{0.4}Al_{0.3}, etc.) and AB2 based alloys (e.g. Ti₁₋ₓZrₓV_{0.5}Ni_{1.1}Mn_{0.2}, etc.). Powders of the metal hydride are preferably coated with either nickel (Ni) or copper (Cu) to improve battery characteristics, such as the prevention of self-discharge of the battery, inhibition of high temperature corrosion, and high rate charge and discharge characteristics. The metal hydride may be formed by pressing.

Further, the metal hydride may be coated with a mixture of nickel and copper.

The electrode material 200 can be formed by pressurizing to make a pellet and crushing the resulted pellet to form agglomerates in various sizes, and then used in the filling process, as shown in (2) of FIG. 3B. When using this method, the resulted electrode material becomes to have a high degree of integration and be uniformly formed. Particularly, when the weight of the electrode material is the same, the capacity of a battery using a strip comprising crushed pellets of metal hydride 200 as disclosed in (3) of FIG. 3A is higher than that of a battery using a strip comprising a pelletized metal hydride 200 in rectangular shape as disclosed in (2) of FIG. 3A. It means that availability of the electrode material is increased in the case of (3) of FIG. 3A.

As described above, the strip 100 filled with electrode material 200 is cut into a certain size, and then connected as shown in FIG. 3C. The strip 100 preferably has a connecting part 107 for connection. In FIG. 3C, the interval between strips 100 having a connecting part 107 is illustrated larger than the actual interval (shown in FIGS. 1A and 1C), for the sake of better understanding.

In order to reduce electric resistance, the connecting parts 107 having been connected to each other are pressurized for stronger connection. Also, the connecting part 107 can be welded. The strip 100, a basic unit of a collector, is further connected with other strips until the predetermined capacity of one sheet of electrode, that is negative plate 18 is achieved. As shown in FIG. 1A, the strip 100 is placed into a groove of a negative plate 300 (See B-B′ line view for detailed view). For reducing electric resistance in thus completed electrode, pressure is finally applied thereto. For facilitating the flow of electric current, the edge of the strip 100 and the negative plate frame 300 are compressed or electric-welded together (along the dotted line represented as W in FIGS. 1A and 1C), completing one negative plate 18 for nickel/metal hydride secondary batteries.

Alternatively, as disclosed in FIG. 1C, the electrode 18 can be formed by inserting each strip 100 one by one into the negative plate frame 300 so as to connect strips 100 as many as they achieve a predetermined electrode capacity, then applying pressure over the whole negative plate frame 300, and compressing or welding the strips 100 and the negative plate frame 300.

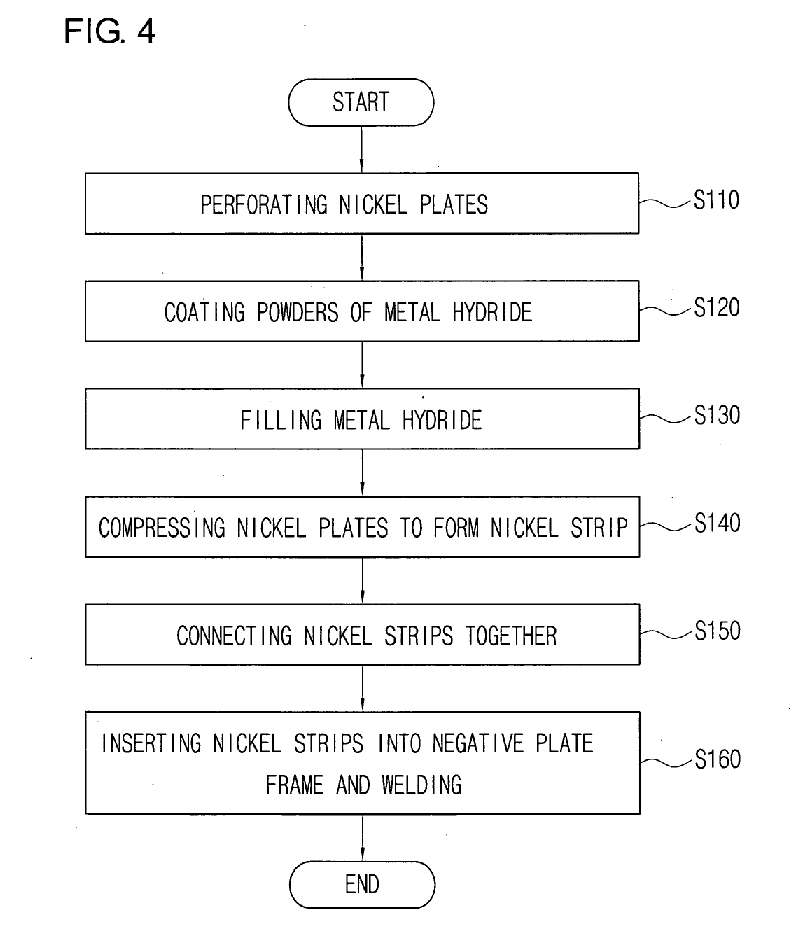

FIG. 4 is a process diagram illustrating the method of fabricating the negative plate for nickel/metal hydride secondary batteries according to a preferred embodiment of the present invention. The fabrication method explained above is summarized with reference to FIG. 4. Firstly, each of the nickel plate 102 is perforated to form a plurality of perforations 110 at step S110. Powders of metal hydride 201 are coated with either nickel (Ni) or copper (Cu) at step S120. Then, the powder type electrode material or the pellet type electrode material (See (3) of FIG. 3B), or electrode material which is formed by crushing the pellet type electrode material, is filled between the two nickel plates 102 facing each other at step S130. The nickel plates 102 are compressed by external pressure, thus form a nickel strip 100 at step S140. As a result, each pair of nickel plates 102 facing each other are combined at each end thereof, respectively, and the electrode material 200 is held between the two nickel plates 102. In other words, the electrode material 200 is maintained as being held in a pair of two nickel plates 102 combined with each other. In order to prevent a reaction of the metal hydride 201 with moisture in the air, fabrication of the negative plate according to the present invention is performed under the conditions of room temperature and a dry atmosphere. The compressed nickel strips 100 are connected two or more so as to achieve the predetermined capacity at step S150. The connected strips 100 are inserted into the negative plate frame 300. After insertion, the both ends of the connected strips are bound to the negative plate frame 300 through compression or welding. The upper strip 100 is welded to the electrode terminal 310 at step S160.

Since the negative plate of the present invention comprises the electrode material 200 held between the combined nickel plates 102, detachment of the metal hydride 201 is prevented at the time discharging the battery. Further, since a binder is not used and optionally the use of a conductor can be eliminated in the present invention, the quantity of the metal hydride contained in the negative plate of the present invention is much larger than that contained in a conventional negative plate.

Moreover, because the nickel strips 100 are disposed at both sides of the electrode material 200, functions of the nickel strips 100 as the collector can be enhanced even though conductor is not used. When the electric current flows to the metal hydride 201 from the nickel strips 100, contact resistance between the nickel strips 100 and the metal hydride 201 is considerably decreased, compared to the conventional negative plates using a binder. Thus, the high rate discharge characteristics of secondary batteries can be increased in a secondary battery employing the negative plate of the present invention. Further, the nickel plates connected to both ends of the electrode active material function as an electric collector, and thus prevent heat from being generated owing to resistance at the time of sudden recharging and discharging of large electric current, thereby greatly increasing the safety characteristics.

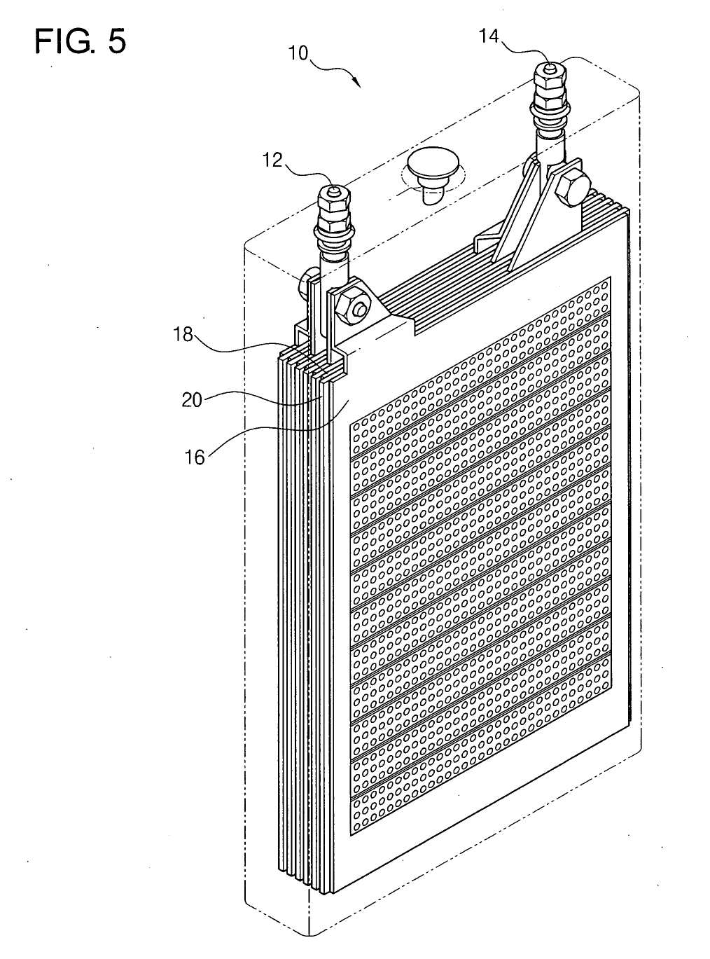

FIG. 5 is a perspective view illustrating a nickel/metal hydride secondary battery including the negative plates 18 according to the present invention. As shown in FIG. 5, the nickel/metal hydride secondary battery comprises a housing 10, a positive terminal 12 and a negative terminal 14 each protruding from the housing 10, positive plates 16 connected to the positive terminal 12, negative plates 18 connected to the negative terminal 14, and separators 20 interposed between the positive plates 16 and the negative plates 18. The positive plates 16, the negative plates 18 and the separators 20 are received in the housing 10.

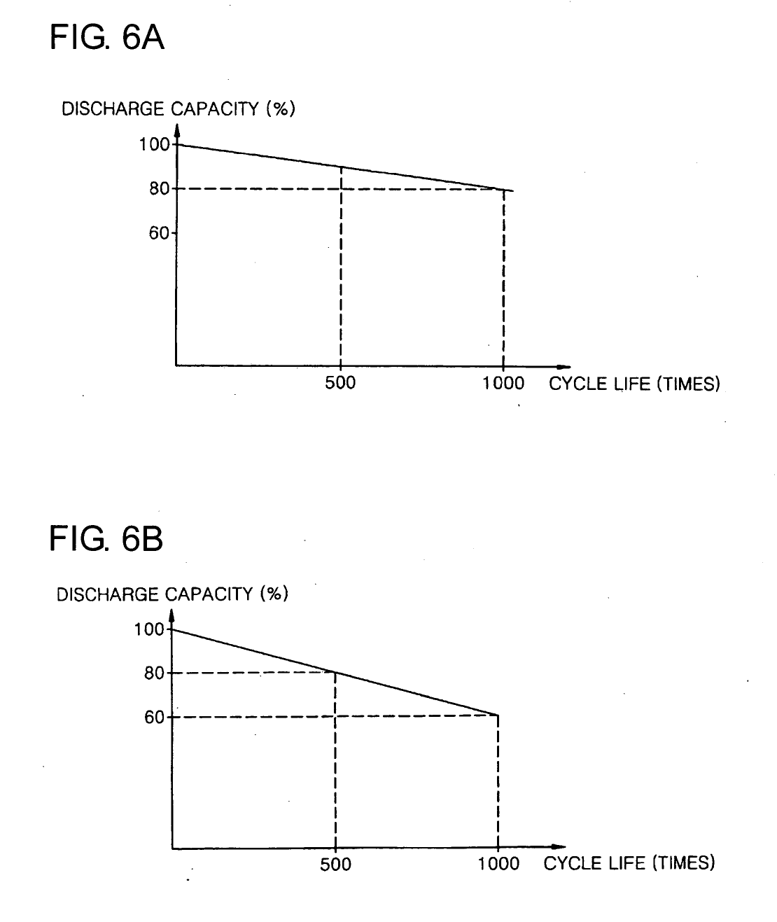

Referring to FIG. 6A, a cycle life of the nickel/metal hydride battery having the negative plates of the present invention is shown. As shown in FIG. 6A, when charge and discharge cycles of such a battery are repeated about 1000 times, a discharge capacity of the battery is close to about 80%. That is, conventional secondary batteries have a discharge capacity of about 80% upon about 500 repetitions of charge and discharge cycles (See FIG. 6B), while the secondary battery having the negative plates according to the present invention has a discharge capacity of about 80% upon about 1000 repetitions of charge and discharge cycles (See FIG. 6A).

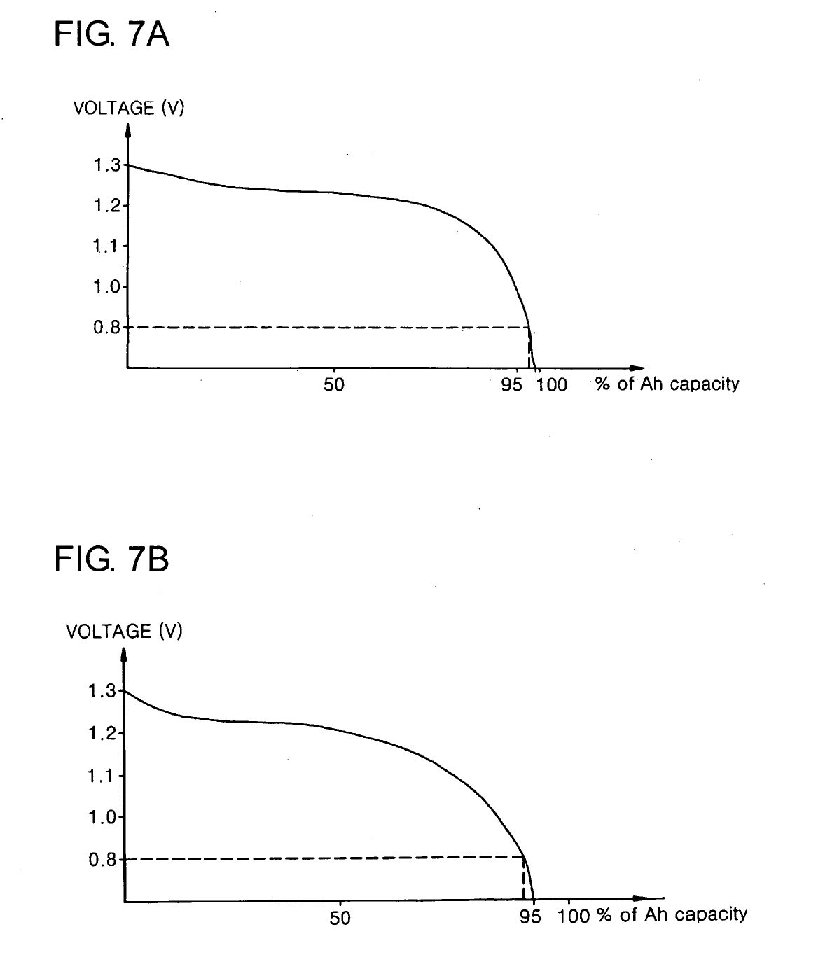

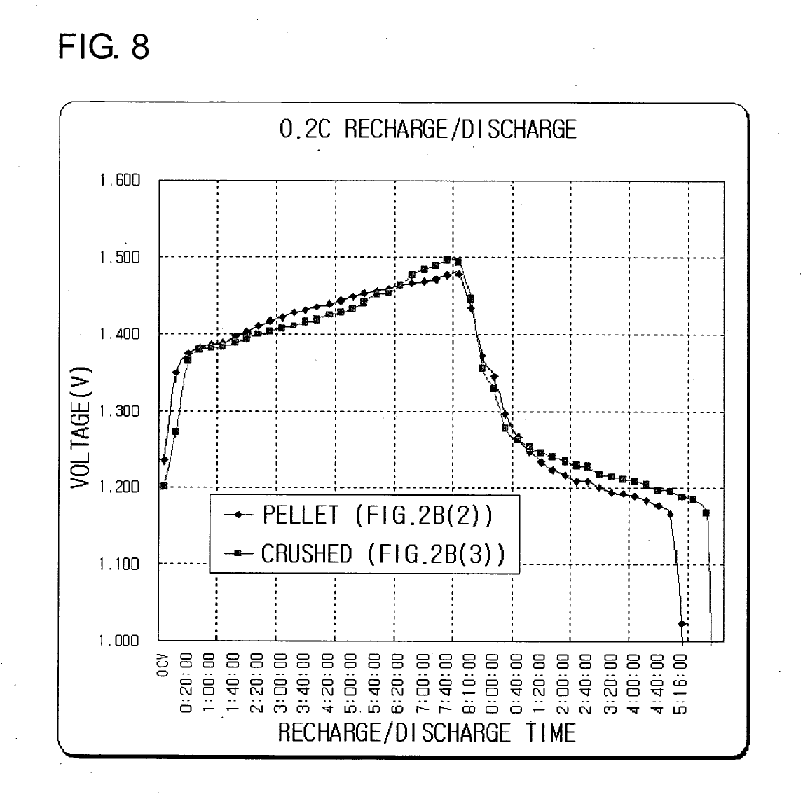

Turning to FIG. 7A, there is shown a high rate discharge characteristic of the nickel/metal hydride secondary battery having the negative plates of the present invention. As shown in FIG. 7A, a discharge capacity is close to about 100% for about 1 hour, on the basis of a 5-hour discharge capacity of 100%. Also, until the battery voltage becomes about 0.8V, secondary batteries having the conventional negative plates have a discharge capacity not exceeding about 95% (See FIG. 7B), whereas the secondary batteries having the negative plates according to the present invention have a discharge capacity exceeding about 95% (See FIG. 7A).

FIG. 8 is a graph illustrating a recharge-discharge characteristics of a nickel/metal hydride secondary battery using the negative plate of the present invention, as a function of time. As it can be seen from FIG. 8, the discharge capacity of the embodiment shown in (3) of FIG. 3B in which the electrode material is compressed and then crushed, is much superior to the discharge capacity of another embodiment shown in (2) of FIG. 3B in which the electrode material is compressed as a pellet.

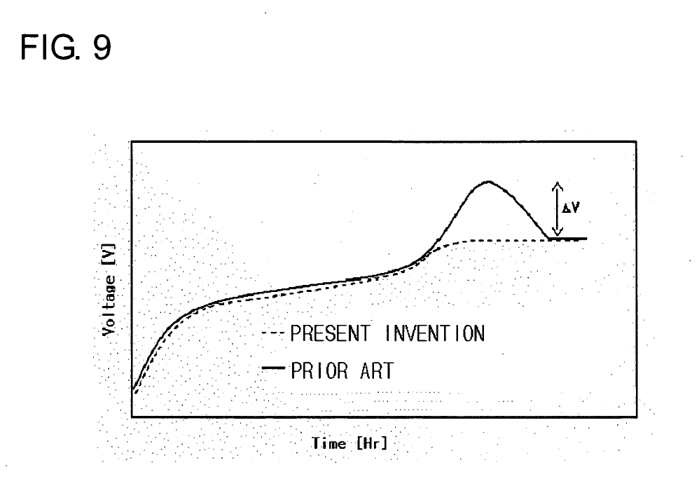

One of the differences between the electrode according to the present invention and an electrode formed by applying a paste type electrode material comprising metal hydride to an electric collector such as a nickel screen, is in polarization resistance and internal resistance of an electrode. In a general recharging curve of a nickel/metal hydride secondary battery formed with paste type electrodes, there is a rise at the end of recharging owing to polarization resistance and internal resistance of the battery, which causes excessive heat in the electrode, which is more than a reaction heat. Owing to such excessive heat, a fall is occurred in the recharging curve. Such behavior of the rise and fall in the recharging curve is referred as □V. The nickel/metal hydride secondary battery according to the present invention does not show □V during recharging, as shown in FIG. 9. This means low polarization resistance and internal resistance of an electrode. Therefore, it significantly reduces the risk owing to heat at the time of battery overcharge.

The present invention has been described in an illustrative manner with reference to a certain embodiment as disclosed in the drawings, however such embodiment has only illustrative purpose. Further, it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

As described above, the present invention provides a negative plate for nickel/metal hydride secondary batteries, in which porous nickel strips, serving as an electric collector, are disposed at both sides of metal hydride by a compressing process. Thereby, even though a binder is not used, metal hydride is contained between the collectors. In addition, electric current from the collector flows efficiently to the metal hydride from the collectors, even though a conductor is not used.

Therefore, the secondary battery having negative plates of the present invention has, but not limited to, the following advantages:

(1) While a quantity of metal hydride used for the negative plates of the present invention is much larger than that for conventional negative plates using a binder and a conductor, detachment of the electrode material owing to expansion or shrinkage of the electrode according to recharge or discharge does not occur, through strong compression by disposing nickel plates or steel plates coated with nickel, instead of porous nickel screens in prior arts. Thus, a cycle life of the secondary battery having the negative plates of the present invention is remarkably lengthened.

(2) Since contact resistance between the collectors and the metal hydride is decreased considerably, high rate discharge characteristics of the secondary battery having the negative plates of the present invention is significantly enhanced. Further, the nickel plates present at both sides of the electrode active material is served as an electric collector. Thus, they prevent heat owing to resistance from being generated during sudden recharging or discharging of a large quantity of electric current, thereby significantly increasing battery safety.

(3) When fabricating an electrode by applying a paste material to a nickel screen, the bigger the size of the electrode, the more difficult to make an electrode uniform. Hence, the battery performance becomes deteriorated and minor short circuits are likely to occur. However, it is possible to make a uniform electrode having a large size, by: placing an electrode material between a perforated nickel plates having a certain size, which is smaller than at least half of the electrode size, thereby forming a nickel strip; then stacking such strips until a predetermined capacity is achieved; and connecting and welding the strips with the frame and terminal. Therefore, the present invention can conveniently fabricate a battery having rather large capacity.

(4) Due to the above advantages of (1) to (3), the secondary battery having negative plates of the present invention is applicable to industrial batteries requiring super high rate charge/discharge characteristics and very long cycle life.

What is claimed is:

1. A method for fabricating a negative plate for nickel/metal hydride secondary batteries, comprised of:
perforating metal plates to have a plurality of perforations;
filling a space between the two metal plates with powders of an electrode material;
compressing the two metal plates having the electrode material therebetween, so as to form a strip;
connecting two or more, as many as being required for a predetermined capacity, strips formed as above; and
inserting connected strips into the negative plate frame so as to connect with an electrode terminal.

2. The method for fabricating a negative plate for nickel/metal hydride secondary batteries as defined in claim 1, further comprising compressing or welding the area where the negative plate frame and the strips are connected, after the step of inserting the strips into the negative plate frame.

3. The method for fabricating a negative plate for nickel/metal hydride secondary batteries as defined in claim 1, wherein the electrode material is comprised of a metal hydride and a conductor.

4. The method for fabricating a negative plate for nickel/metal hydride secondary batteries as defined in claim 1, wherein the metal plate is a plate coated with nickel or a nickel plate.

5. The method for fabricating a negative plate for nickel/metal hydride secondary batteries as defined in claim 1, wherein the strip further comprises a connecting part extended from the end part, and two or more strips can be combined together by binding the connecting parts.

6. The method for fabricating a negative plate for nickel/metal hydride secondary batteries as defined in claim 1, wherein the middle part of the metal plate is recessed so as to receive the electrode material.

7. The method for fabricating a negative plate for nickel/metal hydride secondary batteries as defined in claim 3, further comprising the step of coating the metal hydride with any one selected from nickel or copper, or a mixture of nickel and copper.

8. The method for fabricating a negative plate for nickel/metal hydride secondary batteries as defined in claim 1, wherein the electrode material is filled between the metal plates in the form of a pellet or agglomerates of crushed pellet.

9. A method for fabricating a negative plate for nickel/metal hydride secondary batteries, comprised of:
perforating metal plates to have a plurality of perforations;
filling a space between the two metal plates with powders of an electrode material;
compressing the two metal plates having the electrode material therebetween, so as to form a strip;
inserting the strips at the number corresponding to a predetermined capacity into the negative plate frame; and
combining the two or more strips inserted into the negative plate frame to each other.

10. A negative plate for nickel/metal hydride secondary batteries, comprising:
a negative plate frame;
a terminal connected to the negative plate frame; and
two or more strips inserted into the negative plate frame,
wherein the strip is formed by filling a space between two metal plates having a plurality of perforations formed thereon with electrode material.

11. The negative plate for nickel/metal hydride secondary batteries as defined in claim 10, wherein the electrode material comprises metal hydride and a conductor.

12. The negative plate for nickel/metal hydride secondary batteries as defined in claim 11, wherein the metal hydride is coated with one selected from nickel (Ni) or copper (Cu), or a mixture of nickel and copper.

13. The negative plate for nickel/metal hydride secondary batteries as defined in claim 10, wherein the area where the negative plate frame and the strips are connected is compressed or welded together.

14. The negative plate for nickel/metal hydride secondary batteries as defined in claim 10, wherein the metal plate is a nickel plate.

15. The negative plate for nickel/metal hydride secondary batteries as defined in claim 10, wherein the middle part of the metal plate is recessed so as to receive an electrode material.

16. The negative plate for nickel/metal hydride secondary batteries as defined in claim 10, wherein the electrode material is filled between the metal plates in the form of a pellet or agglomerates of crushed pellet.

17. The negative plate for nickel/metal hydride secondary batteries as defined in claim 10, wherein the diameter of the perforation is tens of micrometers to several millimeters.

18. The method for fabricating a negative plate for nickel/metal hydride secondary batteries as defined in claim 2, wherein the electrode material is comprised of a metal hydride and a conductor.

19. The method for fabricating a negative plate for nickel/metal hydride secondary batteries as defined in claim 2, wherein the metal plate is a plate coated with nickel or a nickel plate.

20. The method for fabricating a negative plate for nickel/metal hydride secondary batteries as defined in claim 2, wherein the strip further comprises a connecting part extended from the end part, and two or more strips can be combined together by binding the connecting parts.

21. The method for fabricating a negative plate for nickel/metal hydride secondary batteries as defined in claim 2, wherein the middle part of the metal plate is recessed so as to receive the electrode material.

22. The method for fabricating a negative plate for nickel/metal hydride secondary batteries as defined in claim 18, further comprising the step of coating the metal hydride with any one selected from nickel or copper, or a mixture of nickel and copper.

23. The method for fabricating a negative plate for nickel/metal hydride secondary batteries as defined in claim 2, wherein the electrode material is filled between the metal plates in the form of a pellet or agglomerates of crushed pellet.

24. The negative plate for nickel/metal hydride secondary batteries as defined in claim 11, wherein the area where the negative plate frame and the strips are connected is compressed or welded together.

25. The negative plate for nickel/metal hydride secondary batteries as defined in claim 11, wherein the metal plate is a nickel plate.

26. The negative plate for nickel/metal hydride secondary batteries as defined in claim 11, wherein the middle part of the metal plate is recessed so as to receive an electrode material.

27. The negative plate for nickel/metal hydride secondary batteries as defined in claim 11, wherein the electrode material is filled between the metal plates in the form of a pellet or agglomerates of crushed pellet.

28. The negative plate for nickel/metal hydride secondary batteries as defined in claim 11, wherein the diameter of the perforation is tens of micrometers to several millimeters.
